(19) United States
(12) Patent Application Publication
(10) Pub. No.: US 2012/0221891 A1
(43) Pub. Date: Aug. 30, 2012

(54) PROGRAMMABLE CONTROLLER

(75) Inventor: Yoshinobu Shimizu, Chiyoda-ku (JP)

(73) Assignee: MITSUBISHI ELECTRIC CORPORATION, Chiyoda-ku, Tokyo (JP)

(21) Appl. No.: 13/395,832

(22) PCT Filed: Feb. 14, 2011
(86) PCT No.: PCT/JP2011/053023

§ 371 Date: Mar. 13, 2012

(51) Int. Cl. G06F 11/07

(52) U.S. Cl. 714/15; 714/E11.023

(57) ABSTRACT

A CPU saves a portion of device data stored in a device memory into a save memory every time a scanning process is performed so that the device data can be reliably saved even if a voltage holding time is shortened due to degradation of an electrolytic capacitor, and when a power-failure detecting circuit detects power failure of a main power supply, the CPU saves a remaining portion of the device data stored in the device memory using a power supply held by the electrolytic capacitor. When a capacity of the electrolytic capacitor detected by a capacitor-capacity detecting circuit is reduced, the CPU changes a size of the device data to be saved by a saving process performed every time the scanning process is performed according to the capacity of the electrolytic capacitor detected by the capacitor-capacity detecting circuit such that the size of the device data to be saved every time the scanning process is performed is increased.

### FIELD

The present invention relates to a programmable controller that controls an FA device.

### BACKGROUND

A programmable controller (hereinafter, simply PLC) used for controlling an FA device uses a state machine as an operation mode, where the original model of the state machine is a relay circuit. A user program described using a programming language in which the relay circuit is symbolized is repeatedly executed, thereby successively updating contact data, which is called device data. Because the device data is usually held in a volatile memory that can operate at a high speed, at the time of power failure, it is necessary to save the device data from the volatile memory into a memory that can hold stored contents even when a main power supply is not supplied.

As a technique for saving device data, the following technique has been known. That is, a backup volatile memory (a save memory) is separately provided, and when a main power supply fails, a power supply for a volatile memory (device data) that holds device data at the time of a normal operation is switched to an auxiliary power supply such as a secondary battery, and a process of saving the device data from the device memory into the save memory is performed using the auxiliary power supply. After the saving process is performed, the power supply for the save memory is switched from the main power supply to the auxiliary power supply so that the device data saved in the save memory can be held also after the main power supply fails.

However, the above technique has a problem that if the volume of the device data becomes large, it takes time to perform the saving process, and thus the capacity of the auxiliary power supply needs to be increased.

In this respect, according to a technique disclosed in Patent Literature 1, in order to prevent a capacity of an auxiliary power supply from increasing, when a main power supply fails, device data is saved from a device memory into a volatile memory whose power supply is backed up by an auxiliary power supply by utilizing power that is supplied for a while even if a power supply voltage starts lowering.

Furthermore, according to a technique disclosed in Patent Literature 2, in order to reduce the volume of data to be saved when a main power supply fails, updated device data is saved from a device memory to a backup volatile memory every predetermined time.

### CITATION LIST

### Patent Literatures

Patent Literature 1: Japanese Patent Application Laid-open No. 2009-181179
Patent Literature 2: Japanese Patent Application Laid-open No. H11-110308
Patent Literature 3: International Publication No. WO2008/016050

### SUMMARY

### Technical Problem

However, the power supply device as described in Patent Literature 1 mentioned above generally includes an electrolytic capacitor to hold a power supply voltage when the main power supply fails. The electrolytic capacitor has characteristics that its capacity is reduced with time. Therefore, at its initial stage, the electrolytic capacitor can secure a voltage holding time long enough to save data stored in a volatile memory when the main power supply fails; however, there is a problem that, as the capacity of the electrolytic capacitor is reduced, the voltage holding time when the main power supply fails becomes shorter and data in the volatile memory cannot be saved.

Furthermore, as described above, a PLC performs sequence control to repeatedly execute a user program. Therefore, in the technique of Patent Literature 2, because the PLC performs the sequence control and a data saving process, there is a problem that the processing amount of the PLC is increased and, as a result, the processing capability for performing the sequence control of the PLC is degraded.

The present invention has been achieved in view of the above problems, and an object of the present invention is to provide a programmable controller that is capable of reliably saving data to be saved at a time of main power supply failure even if a holding time of a power supply voltage is shortened due to aged deterioration.

### Solution to Problem

In order to solve the above problem and in order to attain the above object, a programmable controller of the present invention, includes: a power supply circuit that generates an internal power supply from a commercial power supply, outputs the generated internal power supply, and holds an output of the internal power supply by a capacitor after supply of the commercial power supply is stopped; a volatile device memory in which device data is stored and that holds stored contents using the internal power supply; a save memory that can hold stored contents after supply of the internal power supply is stopped; a computing unit that performs a scanning process of executing a user program and updating device data in the device memory, and that is operated using the internal power supply; a power failure detector that detects stopping of supply of the commercial power supply; and a capacitor capacity detector that detects a capacity of the capacitor. Additionally, the computing unit performs a first saving process of saving a portion of device data stored in the device memory into the save memory every time a scanning process is performed, and when the power failure detector detects stopping of supply of the commercial power supply, the computing unit performs a second saving process of saving a remaining portion of the device data stored in the device memory using the internal power supply held by the capacitor, and when a capacity of the capacitor detected by the capacitor capacity detector is reduced, the computing unit changes a size of device data to be saved by the first saving process according to the capacity of the capacitor detected by the capacitor capacity detector such that the size of the device data to be saved by the first saving process is increased.

### Advantageous Effects of Invention

According to the programmable controller of the present invention, a computing unit performs a first saving process of saving a portion of device data every time a scanning process is performed, and when supply of a commercial power is stopped, the computing unit performs a second saving process of saving remaining data using an internal power supply held by a capacitor. When the capacity of the capacitor is reduced, the computing unit increases the size of the device data to be saved by the first saving process, and therefore, even if a holding time of a power supply voltage is shortened due to aged deterioration, it is possible to reliably save data to be saved at a time of main power supply failure.

### BRIEF DESCRIPTION OF DRAWINGS

FIG. 1 depicts a configuration of a PLC according to an embodiment of the present invention.

FIG. 2 is a timing chart of a status of various outputs at a time of main power supply failure.

FIG. 3 is a flowchart for explaining a process at a time of a normal operation of the PLC according to the embodiment of the present invention.

FIG. 4 is a flowchart for explaining an operation at a time of power failure of a main power supply of the PLC according to the embodiment of the present invention.

### DESCRIPTION OF EMBODIMENTS

Exemplary embodiments of a programmable controller according to the present invention will be explained below in detail with reference to the accompanying drawings. The present invention is not limited to the embodiments.

### Embodiment

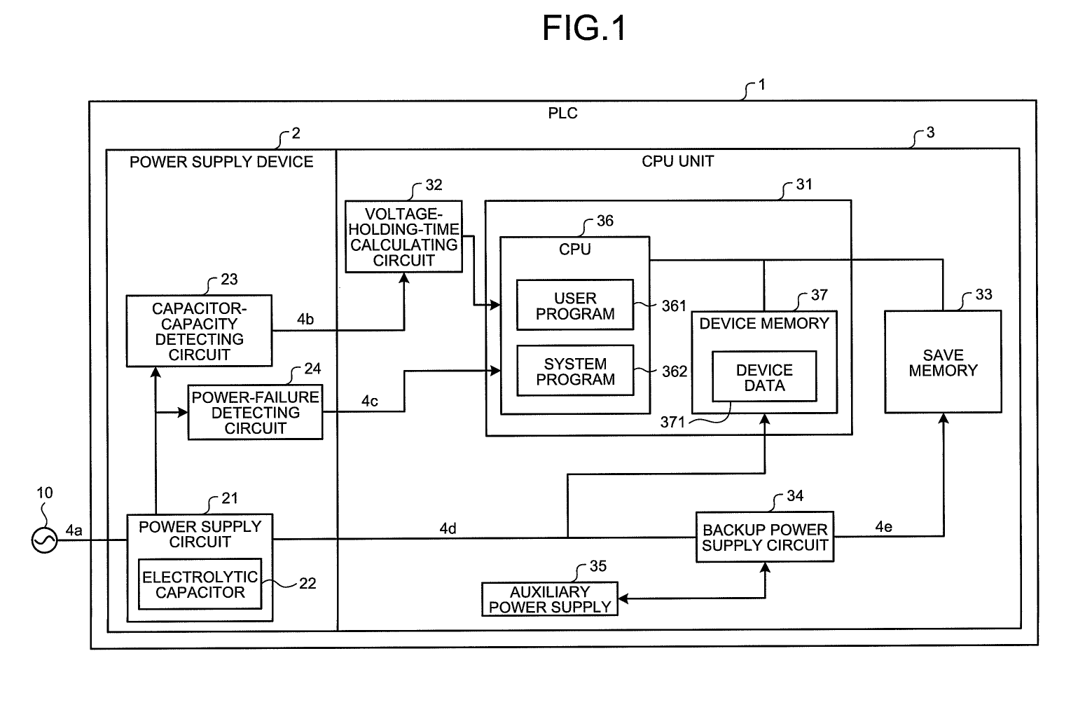

FIG. 1 depicts a configuration of a programmable controller (PLC) according to an embodiment of the present invention. As shown in FIG. 1, a PLC 1 includes a power supply device 2 that generates a main power supply which is supplied from a commercial power supply 10 to the entire PLC 1, and a CPU unit 3 that controls operations of the entire PLC 1. In addition to the power supply device 2 and the CPU unit 3, sub-units (not shown) are also incorporated in the PLC 1. The sub-units perform input and output operations between the PLC 1 and an FA device under control of the CPU unit 3. Examples of the sub-units that can be incorporated in the PLC 1 are a temperature control unit, a network unit, and an analogue unit that performs D/A conversions. A user can select sub-units to be incorporated in the PLC 1 according to his intended use.

The power supply device 2 includes a power supply circuit 21 that generates a power supply (internal power supply) 4d supplied, to the CPU unit 3, from a power supply 4a supplied from the commercial power supply 10. The power supply circuit 21 includes an electrolytic capacitor (capacitor) 22 for holding, for a while, a voltage of the power supply 4d even when supply of the power supply 4a from the commercial power supply 10 is stopped. In the following explanations, the fact that the power supply 4a from the commercial power supply 10 is stopped is occasionally expressed as “power failure of main power supply”.

The power supply device 2 includes a capacitor-capacity detecting circuit (capacitor capacity detector) 23 that detects a remaining capacity of the electrolytic capacitor 22 and outputs remaining capacity information 4b, and a power-failure detecting circuit (power failure detector) 24 that detects whether an output from the commercial power supply 10 to be supplied to the power supply circuit 21 is supplied and then outputs a power-failure detection signal 4c.

The detecting method of the remaining capacity of the electrolytic capacitor 22 by the capacitor-capacity detecting circuit 23 is not particularly limited. For example, it is possible to employ a technique disclosed in Patent Literature 3 such that, in order to detect the remaining capacity of the electrolytic capacitor 22 during execution of a user program (during running), the electrolytic capacitor 22 is duplicated, the electric discharging time of one of the electrolytic capacitors 22 is measured and the remaining capacity is detected based on the measured electric discharging time.

The CPU unit 3 includes a microcomputer 31, a voltage-holding-time calculating circuit 32, a save memory 33, a backup power supply circuit 34 and an auxiliary power supply 35.

The voltage holding time is a time elapsed until the power supply 4d is lowered to an operable voltage of the PLC 1 after power failure of the main power supply.

The voltage-holding-time calculating circuit (holding-time calculating unit) 32 calculates the voltage holding time based on the remaining capacity information 4b that is output by the capacitor-capacity detecting circuit 23. An example of a calculation equation used by the voltage-holding-time calculating circuit 32 to calculate the voltage holding time is described below.

When a remaining capacity notified by the remaining capacity information 4b is denoted as C, and an input voltage of the power supply device 2 is denoted as V₁, a charge quantity Q₁ accumulated in the electrolytic capacitor 22 immediately after power failure of the main power supply is obtained by the following equation.

Q₁=(½)·C·V₁² (1)

When a charging quantity remaining in the electrolytic capacitor 22 after the operation of the PLC 1 is stopped is denoted as Q₂, a power supply efficiency of the commercial power supply 10 is denoted as η, and output electric power of the power supply device 2 is denoted as P, a voltage holding time T₁ is obtained by the following equation.

T₁=(Q₁−Q₂)/Pη (2)

Detection of the remaining capacity is performed by the capacitor-capacity detecting circuit 23 at a predetermined frequency (once a day, for example) and as a result, the voltage holding time that is output by the voltage-holding-time calculating circuit 32 is varied at the predetermined frequency. Because the capacity of the electrolytic capacitor 22 is generally reduced due to aged deterioration, there is a tendency that the voltage holding time is reduced with time.

The save memory 33 is a volatile memory into which device data is saved at the time of power failure of the main power supply. The auxiliary power supply 35 is constituted by a secondary battery or the like. The backup power supply circuit 34 charges the auxiliary power supply 35 using the supplied power supply 4d and supplies a power supply 4e to the save memory 33 when the power supply 4d is supplied from the power supply circuit 21. At the time of power failure of the main power supply, the power supply 4e is supplied to the save memory 33 using electric power discharged from the auxiliary power supply 35. The save memory 33 holds device data saved into the save memory 33 itself by utilizing the power supply 4e.

The microcomputer 31 includes a CPU (computing unit) 36 that executes a user program 361 and a system program 362, and a volatile device memory 37 that holds device data 371. The CPU 36 realizes a basic software environment for controlling the CPU unit 3 by executing the system program 362. The CPU 36 repeatedly performs a scanning process in the software environment realized by the system program 362, where the scanning process includes execution of the user program 361 and updating of the device data 371 in the device memory 37.

The CPU 36 saves a portion of the device data 371 in the device memory 37 into the save memory 33 every time a scanning process is performed (first saving process), so that the device data 371 can be saved without fail even if the voltage holding time is shortened as compared with the voltage holding time in a state of shipment due to degradation of the electrolytic capacitor 22. The CPU 36 saves remaining data of the device data 371 in the device memory 37 using the power supply 4d held by the electrolytic capacitor 22 when the power-failure detecting circuit 24 detects power failure of the main power supply (second saving process). When the capacity of the electrolytic capacitor 22 detected by the capacitor-capacity detecting circuit 23 is reduced, the CPU 36 changes the size of the device data 371 to be saved by the saving process that is performed every time a scanning process is performed according to capacity of the electrolytic capacitor 22 detected by the capacitor-capacity detecting circuit 23, such that the size of the device data 371 to be saved every time the scanning processing is performed is increased.

More specifically, the CPU 36 calculates the size of the device data 371 that can be saved at a time during the voltage holding time T₁ calculated by the voltage-holding-time calculating circuit 32 (hereinafter, the size is referred to as “savable size”). When the savable size is smaller than the total size of the device data 371, a portion of the size of the device data 371 that cannot be saved during the voltage holding time T₁ is saved in advance. Every time the scanning process is performed, the CPU 36 performs the above processes based on a calculating process of the savable size to the saving process of the partial device data 371. If the power failure of the main power supply is detected by the power-failure detection signal 4c that is output by the power-failure detecting circuit 24, the remaining portion of the device data 371 that has not been saved by the saving process performed every time the scanning process is performed is saved into the save memory 33.

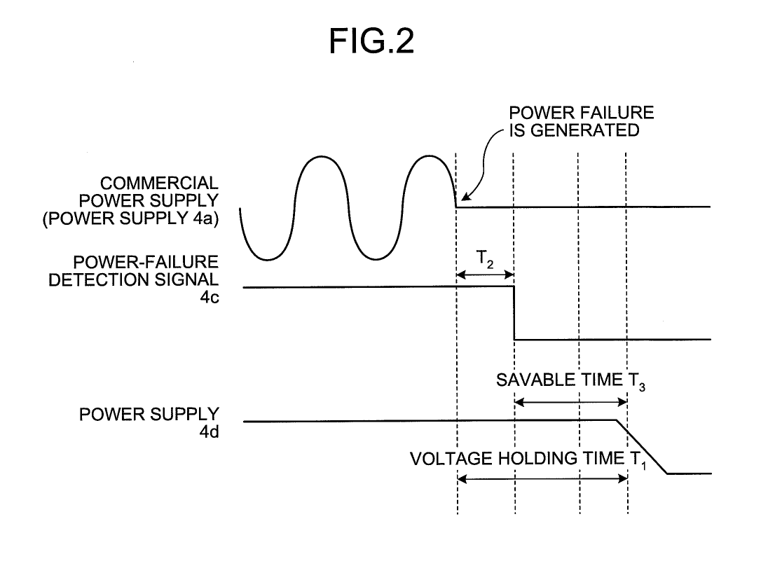

For example, as shown in the timing chart in FIG. 2, when a time elapsed after the main power supply fails until the power-failure detecting circuit 24 detects the power failure of the main power supply and outputs this fact to the power-failure detection signal 4c is denoted as T₂, a time (a savable time) T₃ that can be practically used for saving the device data 371 is a value obtained by subtracting the time T₂ from the voltage holding time T₁. Therefore, when a charge quantity remaining in the electrolytic capacitor 22 when the PLC 1 stops its operation is denoted as Q₂ and a power supply efficiency of the commercial power supply 10 is denoted as η, the following equation is established.

T₃=[{(½)·C·V₁²−Q₂}/Pη]−T₂ (3)

It is preferable that the values of P, Q₂, η, and T₂ are obtained by a measurement or the like in advance.

It is possible to obtain the savable size by dividing the savable time T₃ obtained by the equation (3) by a transmission speed when data is transmitted from the device memory 37 to the save memory 33.

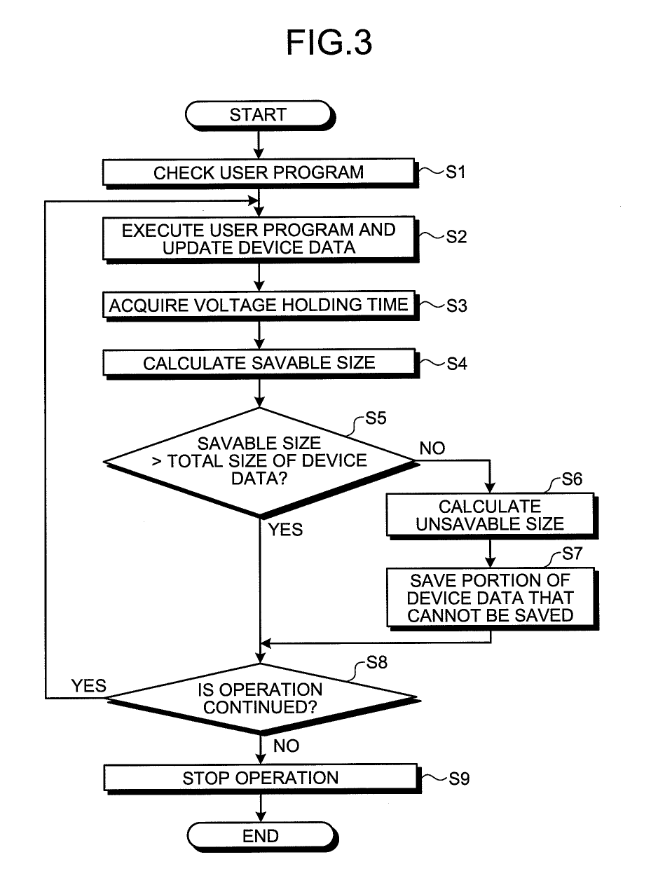

FIG. 3 is a flowchart for explaining a process at a time of a normal operation of the PLC 1 according to the embodiment of the present invention. As shown in FIG. 3, the CPU 36 performs checking of the user program 361 (Step S1). After checking the program, the CPU 36 executes the user program 361 and performs updating of the device data 371 (Step S2).

Thereafter, the CPU 36 acquires a voltage holding time that is output from the voltage-holding-time calculating circuit 32 (Step S3), and obtains a savable size based on the acquired voltage holding time (Step S4). The CPU 36 then determines whether the obtained savable size is greater than the total size of the device data 371 (Step S5).

When the savable size is smaller than the total size of the device data 371 (NO at Step S5), the CPU 36 subtracts the savable size from the total size of the device data 371, and calculates the total size that cannot be saved within the voltage holding time (an unsavable size) (Step S6). The CPU 36 then saves the unsavable size of the device data 371 into the save memory 33 (Step S7). The method of determining a portion of the device data 371 to be saved is not particularly limited. For example, a portion of the data that has been updated by the process at Step S2 can be saved preferentially.

When the obtained savable size is greater than the total size of the device data 371 (YES at Step S5), or after the process at Step S7 is performed, the CPU 36 determines whether the operation is continued (Step S8). Particularly in a case when a stopping command is not internally issued, for example, the CPU 36 determines that the operation is continued (YES at Step S8), and the operation is shifted to the process at Step S2. When the operation is not continued (NO at Step S8), the CPU 36 stops the operation (Step S9) and the normal operation is finished.

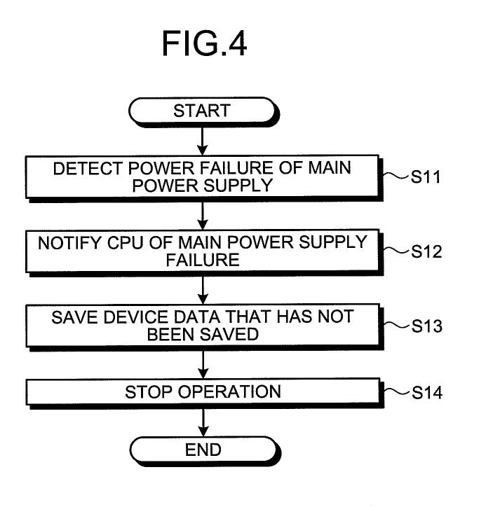

FIG. 4 is a flowchart for explaining an operation at a time of power failure of a main power supply of the PLC 1 according to the embodiment of the present invention. When the main power supply fails, the power-failure detecting circuit 24 first detects the power failure of the main power supply (Step S11). The power-failure detecting circuit 24 having detected the power failure of the main power supply notifies the fact to the CPU 36 using the power-failure detection signal 4c (Step S12). If the process at Step S7 has been already performed when the CPU 36 has received this notification, the CPU 36 saves the remaining portion of the device data 371 that has not been saved by the process at Step S7, and if the process at Step S7 has not been performed, the CPU 36 saves the entire device data 371 from the device memory 37 into the save memory 33 (Step S13). The CPU 36 then stops the operation (Step S14), and the operation at the time of the power failure of the main power supply is finished.

Among the operations shown in FIGS. 3 and 4, operations of the CPU 36 are realized by the system program 362.

Although it has been explained that the voltage-holding-time calculating circuit 32 calculates the voltage holding time and the CPU 36 calculates the savable time based on the calculated voltage holding time, it is also possible to configure that the CPU 36 calculates the voltage holding time based on a detection value of the electrolytic capacitor 22 and then calculates the savable time based on the calculated voltage holding time. Alternatively, it is also possible to configure that the voltage-holding-time calculating circuit 32 calculates the savable time and inputs a result thereof to the CPU 36.

As described above, according to the embodiment of the present invention, the CPU 36 saves a portion of the device data 371 stored in the device memory 37 into the save memory 33 every time the scanning process is performed, and when the power-failure detecting circuit 24 detects power failure of the main power supply, the CPU 36 saves the remaining portion of the device data 371 stored in the device memory 37 using the power supply 4d held by the electrolytic capacitor 22, and if the capacity of the electrolytic capacitor 22 detected by the capacitor-capacity detecting circuit 23 is reduced, the size of the device data to be saved by the saving process that is performed every time the scanning process is performed according to the capacity of the electrolytic capacitor 22 detected by the capacitor-capacity detecting circuit 23 such that the size of the device data 371 that is to be saved every time the scanning process is performed is increased. Therefore, even if the holding time of the internal power supply is shortened due to aged deterioration of the electrolytic capacitor 22, it is possible to reliably save data that is to be saved at the time of power failure of main power supply. Furthermore, because the size of the data to be saved by the saving process performed every time the scanning process is performed is changed according to the capacity of the electrolytic capacitor 22, it is possible to reduce the time required for the saving process performed every time the scanning process is performed as compared with a case where updated device data is merely saved every time the scanning process is performed. Therefore, it is possible to suppress the degradation of the processing capability of sequence control caused by the saving process performed every time the scanning process is performed.

Furthermore, it is configured that the programmable controller further includes the voltage-holding-time calculating circuit 32 that calculates, based on the capacity of the electrolytic capacitor 22 detected by the capacitor-capacity detecting circuit 23, a holding time of an output of the power supply 4d after power failure of main power supply, and the CPU 36 subtracts a savable size within the holding time calculated by the voltage-holding-time calculating circuit 32 from the total size of the device data 371 stored in the device memory 37, and then calculates the size of the device data 371 that is to be saved by the saving process every time the scanning process is performed. Therefore, even if the holding time of the internal power supply is shorted due to aged deterioration of the electrolytic capacitor 22, it is possible to reliably save data to be saved at the time of power failure of main power supply, and to suppress degradation of the processing capability of sequence control caused by the saving process.

### INDUSTRIAL APPLICABILITY

As described above, the programmable controller according to the present invention is suitable for applications for programmable controllers that control an FA system.

### REFERENCE SIGNS LIST

1 PLC
2 power supply device
3 CPU unit
10 commercial power supply
21 power supply circuit
22 electrolytic capacitor
23 capacitor-capacity detecting circuit
24 power-failure detecting circuit
31 microcomputer
32 voltage-holding-time calculating circuit
33 save memory
34 backup power supply circuit
35 auxiliary power supply
36 CPU
37 device memory
361 user program
362 system program
371 device data

1. A programmable controller comprising:
a power supply circuit that generates an internal power supply from a commercial power supply, outputs the generated internal power supply, and holds an output of the internal power supply by a capacitor after supply of the commercial power supply is stopped;
a volatile first memory that holds data using the internal power supply;
a second memory capable of holding data after supply of the internal power supply is stopped;
a power failure detector that detects stopping of supply of the commercial power supply;
a capacitor capacity detector that detects a capacity of the capacitor,
a computing unit, wherein
the computing unit performs a first saving process of saving a portion of device data stored in the first memory into the second memory during supply of the commercial power supply, and when the power failure detector detects stopping of supply of the commercial power supply, the computing unit performs a second saving process of saving a remaining portion of the data stored in the first memory into the second memory using the internal power supply held by the capacitor, and
the computing unit changes a size of device data to be saved by the first saving process according to the capacity of the capacitor detected by the capacitor capacity detector.

2. The programmable controller according to claim 1, further comprising a holding-time calculating unit that calculates, based on the capacity of the capacitor detected by the capacitor capacity detector, a holding time of an output of the internal power supply after supply of the commercial power supply is stopped, wherein
the computing unit subtracts a savable size of data within a holding time calculated by the holding-time calculating unit from a total size of data in the first memory, and calculates a size of data to be saved by the first saving process.

3. The programmable controller according to claim 1, wherein the computing unit performs a scanning process of executing a user program and updating data in the first memory, and performs the first saving process every time the scanning process is performed.

4. The programmable controller according to claim 1, wherein when a capacity of the capacitor detected by the capacitor capacity detector is reduced, the computing unit increases the size of the data to be saved by the first saving process.
